(19) United States
(12) Patent Application Publication
(10) Pub. No.: US 2009/0001797 A1
(43) Pub. Date: Jan. 1, 2009

(54) Backrest Pivot

(75) Inventor: Guido Neumann, Ilmenau (DE)

Correspondence Address: KING & SPALDING, 1185 AVENUE OF THE AMERICAS, NEW YORK, NY, 10036-4003, US

(73) Assignee: Brose Fahrzeugteile GmbH & Co., Coburg (DE)

(21) Appl. No.: 11/996,883

(22) PCT Filed: May 30, 2006
(86) PCT No.: PCT/EP06/05118

§ 371 Date: Mar. 12, 2008

(30) Foreign Application Priority Data
Aug. 12, 2005 (DE) 20 2005 012 733.7

(51) Int. Cl. B60N 2/20

(52) U.S. Cl. 297/378.12

(57) ABSTRACT

This invention relates to a backrest pivot that includes a first fitting attached to a seat bottom part, an angle adjuster that is mounted so as to be rotatable and adjustable relative to the first fitting, and a second fitting attached to a backrest. The backrest pivot includes a locking latch that can be actuated by a bolt and with which there are associated a first catch for fixing the backrest in a comfortable position and a second catch for fixing the backrest in a folded-forward position. The backrest pivot includes a mechanism by means of which the fixing of the backrest in the folded-forward position can be cancelled by a first and a second means which can be actuated independently of each other.

### BACKGROUND OF THE INVENTION

In the case of two-door vehicles, the task of climbing into the rear of the vehicle is facilitated for passengers as a result of the fact that the backrest of the driver's/front passenger's seat is folded forward and the means for longitudinally adjusting the seat is disengaged. When the backrest is folded forward, the seat can thus be moved right into the furthest forward position. In order to return to the set longitudinal position once the passenger has climbed in, seats of this type have an easy-entry function in which a positioning stop can be deposited in the guide rail of the longitudinal adjustment means. The positioning stop moves in conjunction with the seat only once the means for disengaging the longitudinal adjustment means has been actuated—if the backrest is folded forward to allow a passenger to climb in, the positioning stop is deposited in the guide rail attached to the floor of the vehicle and thus marks the set longitudinal position of the seat that can be returned to once the backrest has been folded back. A means of this type is known from DE 103 13 807 A1, DE 100 12 009 A1 and 10057 724 A1.

A seat pivot of this type is convenient if the disengagement of the backrest by the lever of the backrest disengagement means also disengages the longitudinal engagement means of the seat, allowing the seat to be displaced forward. The folded-forward backrest is engaged in this position. In this case, the backrest swivels back into the normal seat position when the seat reaches the longitudinal position defined by the positioning stop (memory module). Contact with the positioning stop disengages the engagement of the backrest in the folded forward position. The backrest can be swiveled back again. The swiveling-back of the backrest then actuates the longitudinal engagement means.

In order to be able to utilize the seat even in a position which does not correspond to the position defined by the positioning stop (this being prevented, for example, by luggage in the rear of the vehicle), the backrest lever disengages the backrest engagement means in the furthest forward position—folding-back of the backrest allows the seat to be locked in a position preceding the positioning stop. The backrest pivot associated with the seat fitting of the backrest angle setting has for this purpose a mechanism which disengages the means for engaging the backrest in the folded-forward position, starting both from the backrest lever and from contact with the positioning stop.

### SUMMARY OF THE INVENTION

The invention is based on the object of improving a backrest pivot of the type mentioned at the outset, in particular with regard to the complexity of the components.

According to the invention, this problem is solved by providing a novel backrest pivot. The backrest pivot includes a first fitting attached to a seat bottom part, an angle adjuster that is mounted so as to be rotatable and adjustable relative to the first fitting, a second fitting to which a backrest is attached. Furthermore, the backrest pivot includes a locking latch that can be actuated by means of a bolt and with which there are associated a first catch for fixing the backrest in a comfortable position and a second catch for fixing the backrest in a folded-forward position. The backrest pivot also includes a mechanism by means of which the fixing of the backrest in the folded-forward position can be cancelled by a first and a second means which can be actuated independently of each other, wherein the first means for releasing the fixing of the backrest in the folded-forward position acts on the bolt and the second means is associated with the end of the locking latch that interacts with the second catch.

### BRIEF DESCRIPTION OF THE DRAWINGS

FIG. 1 is a perspective view of the individual parts of the backrest pivot according to the invention.

FIG. 2 shows an upright engaged position of the fitting.

FIG. 3 shows an upright engaged position of the fitting.

FIG. 4 shows the swiveling of the bolt.

FIG. 5 shows the swiveling of the bolt.

FIG. 6 shows the interaction between the locking latch and the catch.

FIG. 7 shows a specific swivel angle.

FIG. 8 shows the folded-forward angle.

FIG. 9 shows the swiveled-forward position.

FIG. 10 shows the pivotable mounting of the lever.

FIG. 11 shows the folded-forward position.

FIG. 12 shows the folded-forward position.

### DETAILED DESCRIPTION OF THE INVENTION

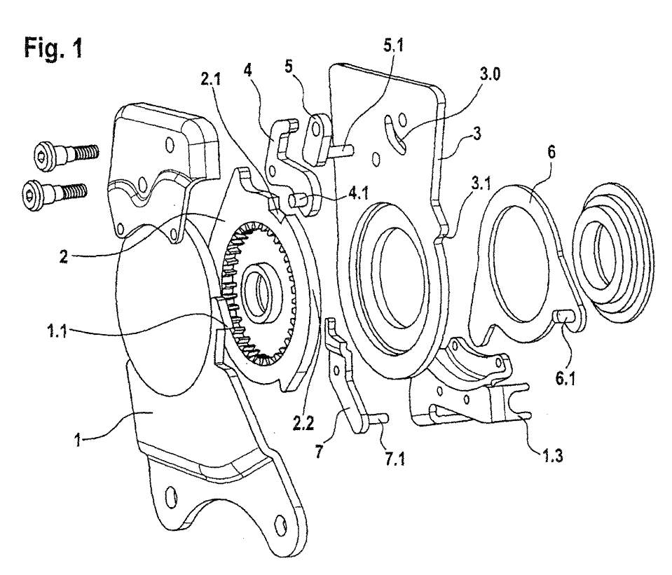

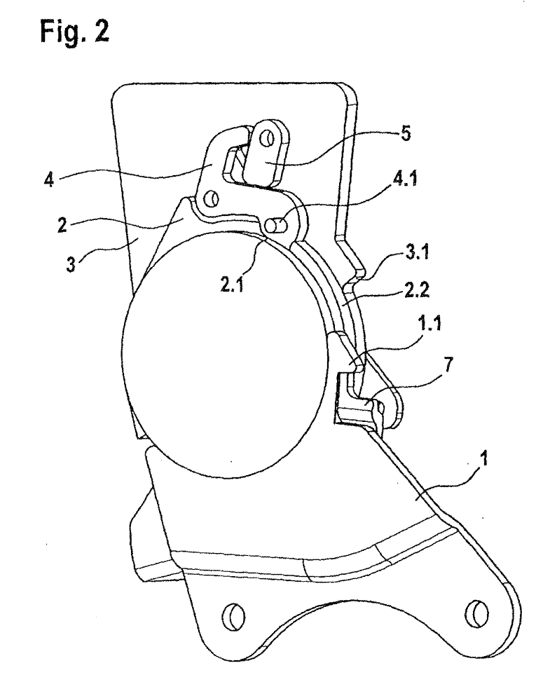

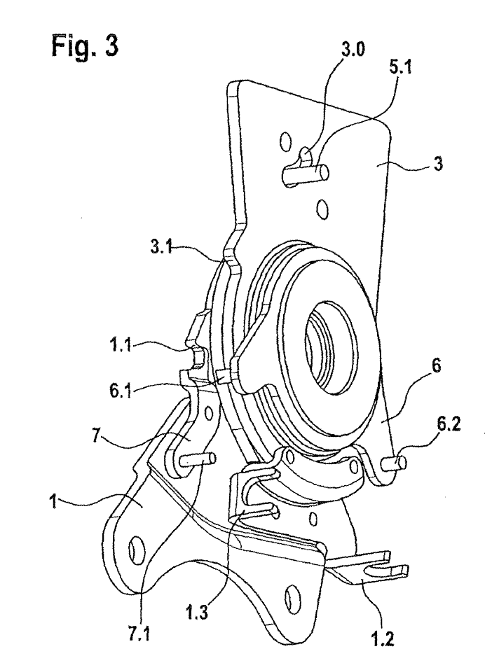

FIG. 1 is a perspective view of the individual parts of the backrest pivot according to the invention. A first fitting 1, which is attached to the seat bottom part (not shown), interacts with an angle adjuster 2 in a manner known per se, operating in accordance with the wobble principle, as an angle adjuster. The fitting 3, which carries the backrest (not shown), forms the backrest pivot with the angle adjuster 2. For this purpose, a locking latch 4, which interacts with a first catch 2.1 on the angle adjuster, is articulated to the fitting 3 so as to be able to rotate. The locking latch 4 in the first catch 2.1 defines the upright position of the backrest. The locking latch 4 is engaged via a bolt 5 which is articulated to the fitting 3 so as to be able to rotate. The bolt 5 can be actuated via a pin 5.1 which is guided through an opening 3.0 and connected on the other side of the fitting 3 to a Bowden cable (not shown) which can be actuated by a lever attached to the foldable backrest. FIGS. 2 and 3 show in this regard the upright engaged position of the fitting 3.

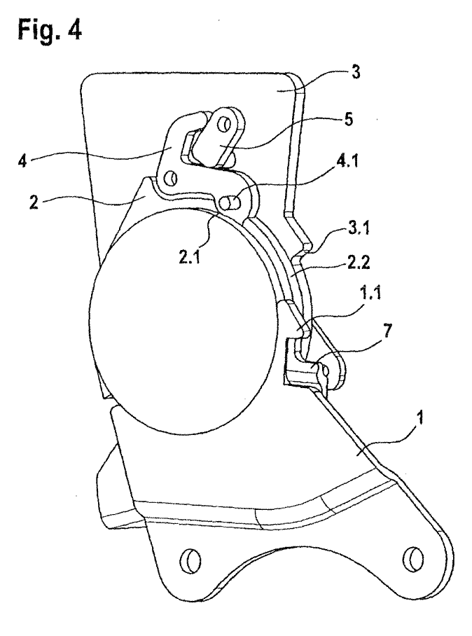

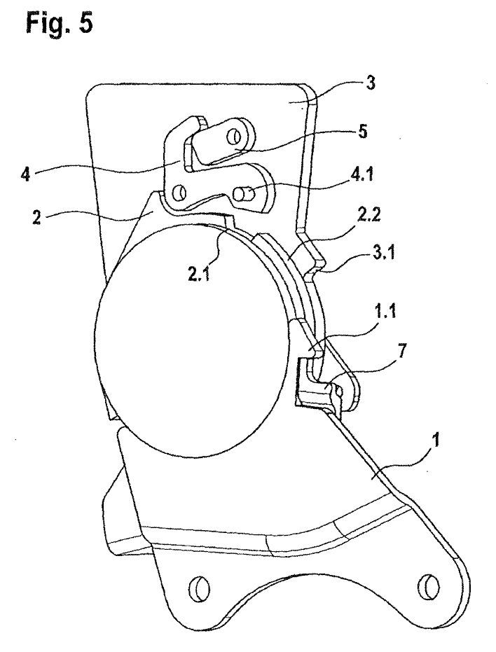

FIGS. 4 and 5 show the swiveling of the bolt 5 which acts in this case on the end of the locking latch 4 that is remote from the catch 2.1. The contact with the end of the locking latch 4 is produced in this case, firstly, in proximity to the pivot axis of the bolt 5 (FIG. 4); on further swiveling of the bolt 5, contact zone between the bolt 5 and locking latch 4 moves away from the pivot axis of the bolt 5 (FIG. 5).

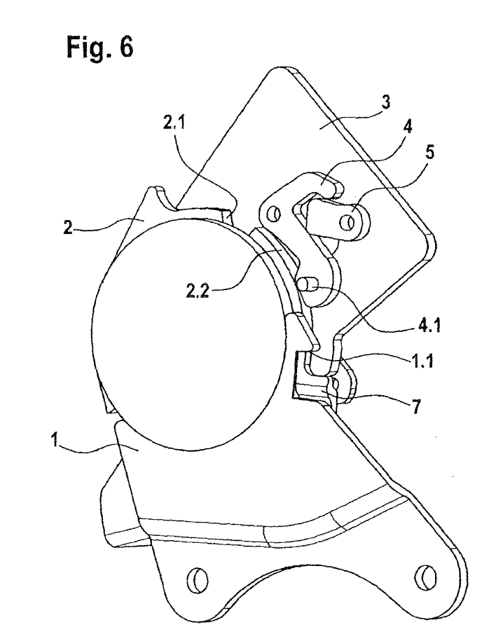

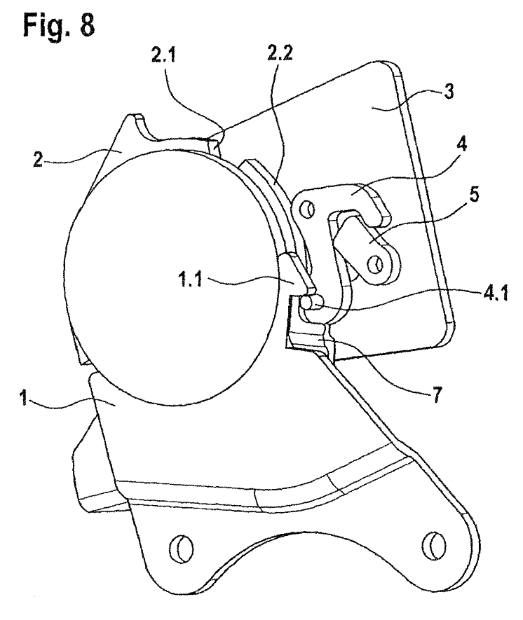

Once the locking latch 4 has swiveled fully out of the catch 2.1, the fitting 3 can be folded forward together with the backrest. The end of the locking latch 4 that interacts with the catch 2.1 slides in this case on a contour 2.2 of the angle adjuster 2 (FIG. 6). For locking the folded-forward position of the backrest, the locking latch 4 has a pin 4.1 interacting with a second catch 1.1 on the fitting 1. In the folded-forward position, the backrest thus assumes at all times—irrespective of the previously set comfortable position—the same folded-forward angle (FIG. 8). As in this case the end of the locking latch 4 rests on the contour 2.2, the pin 4.1 interacts with the catch 1.1 so as to be able to be lifted out of the catch 1.1 by way of the lever 7.

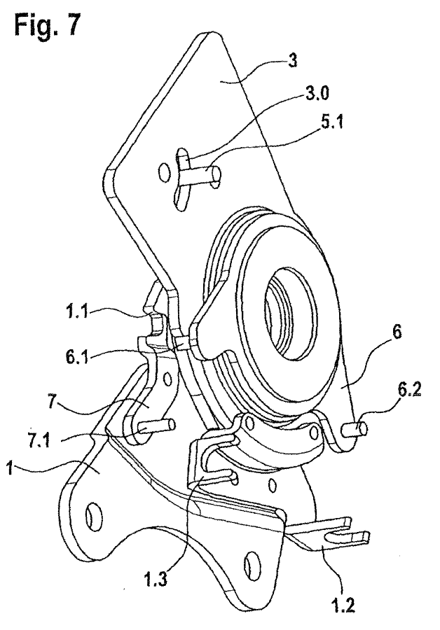

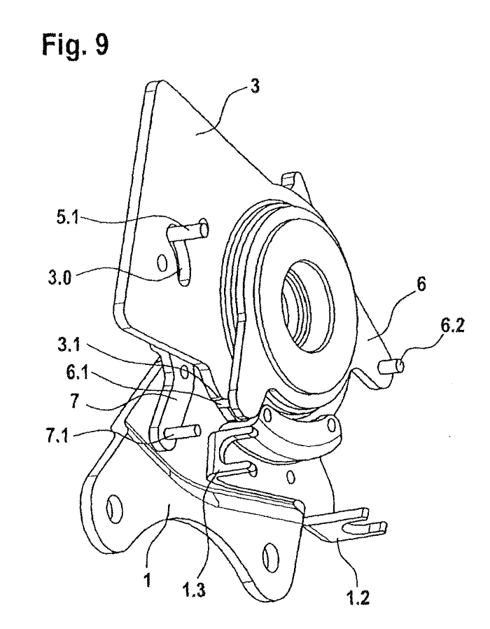

During folding forward of the backrest, the longitudinal adjustment of the vehicle seat has to be disengaged. For this purpose, the fitting 3 has a contour 3.1 interacting with an entrainment means 6.1 of an entrainment ring 6 which is mounted so as to be able to rotate relative to the fitting 3. In this case, the contour 3.1 and entrainment means 6.1 enter into contact only once the backrest and the fitting have traveled a specific swivel path (cf. in this regard FIG. 3-FIG. 7), so the longitudinal engagement means is actuated only after a specific swivel angle (FIG. 7-FIG. 9). The entrainment ring 6 has an articulation 6.2 for a Bowden cable (not shown) which, when the backrest is swiveled forward, disengages the longitudinal engagement means and at the same time deposits the positioning stop of the easy-entry means. The support 1.2 for the Bowden tube (not shown) is attached to the fitting 1.

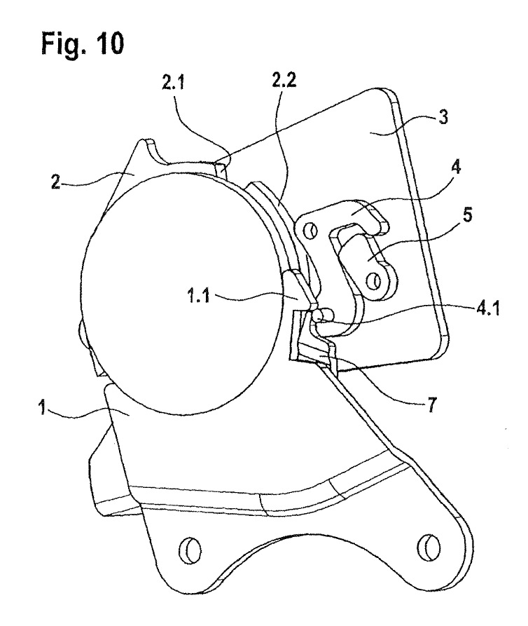

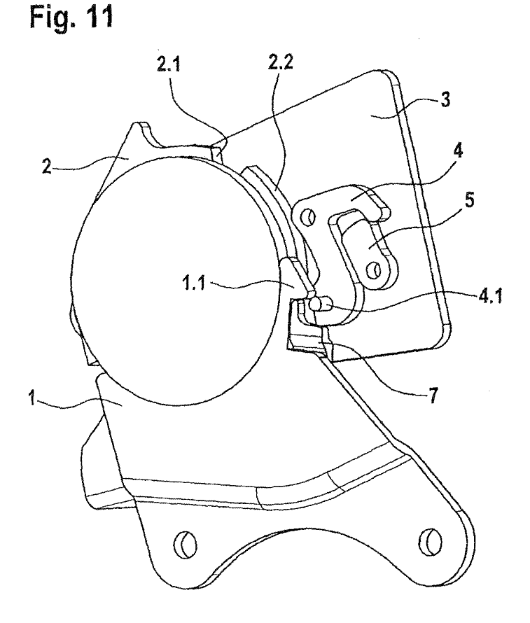

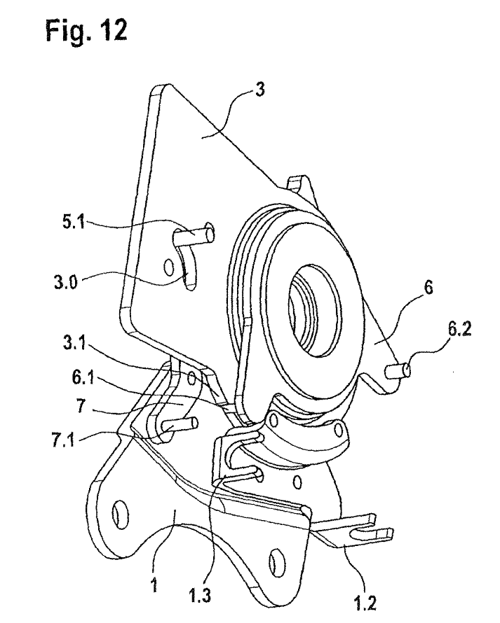

If the seat is moved back, with the backrest folded forward and engaged, toward the easy-entry positioning stop (starting from the position according to FIG. 8), the engagement of the folded-forward backrest can be released on contact with the easy-entry positioning stop. For this purpose, the pivotable end of a lever 7, which is pivotably mounted on the fitting 1 and allows the pin 4.1 of the locking latch 4 to be released from the second catch 1.1 (FIGS. 8, 10), is associated with the second catch 1.1 interacting with the pin 4.1. The pivotable lever 7 has on the pin 7.1 an articulation for a Bowden cable (not shown) which swivels the lever 7 when the seat enters into contact with the easy-entry positioning stop. The Bowden tube is received on a support 1.3 of the fitting 1. The backrest is disengaged from the folded-forward position via the disengagement lever, which is attached to the backrest, by way of the bolt 5 which acts directly on the locking latch 4 (FIGS. 8, 11 and 12). In this way, the means for engaging the backrest in the folded-forward position can be disengaged both by the backrest bolt—the seat not being in the easy-entry position—and by reaching the easy-entry position. Folding the backrest back into the comfortable position then engages the longitudinal engagement means—the seat can therefore be engaged both in the easy-entry position and also before it.

1. A backrest pivot for a vehicle seat comprising
a first fitting attached to a seat bottom part,
an angle adjuster that is mounted so as to be rotatable and adjustable relative to the first fitting,
a second fitting to which a backrest is attached,
a locking latch that can be actuated by means of a bolt and with which there are associated a first catch for fixing the backrest in a comfortable position and a second catch for fixing the backrest in a folded-forward position, and
a mechanism for cancelling the fixing of the backrest in the folded-forward position, the cancellation by a first and a second device which can be actuated independently of each other,
wherein the first device for releasing the fixing of the backrest in the folded-forward position acts on the bolt and the second device is associated with the end of the locking latch that interacts with the second catch.

2. The backrest pivot as claimed in claim 1, wherein the first device is a manually actuatable lever attached to the backrest.

3. The backrest pivot as claimed in claim 1, wherein the bolt can be actuated via a sheathed cable.

4. The backrest pivot as claimed in claim 1, further comprising a mechanism associated with the seat that comprises a positioning stop, for longitudinally adjusting the seat, wherein, when the mechanism for longitudinally adjusting the seat is disengaged, the seat is movable up to the positioning stop and, on contact with the positioning stop, the end of the locking latch that interacts with the second catch can be actuated.

5. The backrest pivot as claimed in claim in claim 1, further comprising a lever that is associated with the second catch, and by means of which the end of the locking latch can be released from the second catch.

6. The backrest pivot as claimed in claim 5, wherein the pivotable end of the locking latch has a pin interacting with the second catch.

7. The backrest pivot as claimed in claim 5, wherein the lever can be actuated via a sheathed cable.

8. The backrest pivot as claimed in claim 4, further comprising an entrainment ring that is associated with the fitting carrying the backrest, wherein the entrainment ring is adapted to actuate the longitudinal engagement mechanism of the seat.

9. The backrest pivot as claimed in claim 8, wherein the entrainment ring has an entrainment mechanism interacting with a contour on the fitting.
